(19) United States
(12) Patent Application Publication
(10) Pub. No.: US 2005/0289004 A1
(43) Pub. Date: Dec. 29, 2005

(54) Method and system for enhancing classified ads

(76) Inventor: Qiu-Jiang Lu, Mountain View, CA (US)

Correspondence Address: QIU-JIANG LU, 825 SONIA WAY, MOUNTAIN VIEW, CA, 94040, US

(21) Appl. No.: 11/120,121

(22) Filed: May 2, 2005

Related U.S. Application Data
(60) Provisional application No. 60/582,987, filed on Jun. 25, 2004.

(51) Int. Cl. G06F 17/00

(52) U.S. Cl. 705/14

(57) ABSTRACT

The present invention provides a method and system for registering and enhancing a traditional paper-based classified ad. The ad is placed by an advertiser and received by a server system of a website. The server system receives ad information such as for-sale item description, accepted payment methods, and advertiser's contact phone number etc. The server system registers the ad, and assigns the ad a unique identifier. The server system then creates web addresses for the ad with a direct combination of the website's domain name and the ad identifier or the phone number. The server system provides the advertiser the web addresses for inclusion into a paper-based ad or for telling ad inquirers via phone. The server system then allows a reader of the paper-based ad to access the ad with the web addresses, and displays detailed ad information to the reader. The server system may also concurrently serve other advertisers for ad registering as well as other ad readers for ad detail viewing.

### CROSS-REFERENCE TO RELATED APPLICATIONS

The present application is the regular patent application as a continuing prosecution application of provisional application Appl. No. 60/582,987, filed June. 25, 2004 entitled METHOD AND SYSTEM FOR ENHANCING CLASSIFIED ADS.

### FEDERALLLY SPONSORED RESEARCH

Not Applicable

### SEQUENCE LISTING OR PROGRAM

Not Applicable

### FIELD OF THE INVENTION

The present invention relates to a computer method and system for registering and enhancing classified ads and, more particularly, to a web-based method and system for registering and enhancing traditional paper-based classified ads.

### BACKGROUND OF THE INVENTION

Paper-based classified ads produced by the print media publishers have proven very useful and cost effective in bringing buyers and sellers together. Hereafter, the terms seller(s) and advertiser(s) as well as buyer(s) and ad reader(s) are interchangeable; and for simplicity of discussion, newspaper classified ads in particular are used as example of paper-based classified ads. Newspaper classified ads have long been the average person's first stop in seeking for goods or services. But, newspaper classified ads have their disadvantages. For example, newspaper classified ads tend to show limited item description because of the need to save ad space and reduce cost. Additionally, the newspapers are typically incapable of doing anything more than providing minimal classification for the items advertised.

Conventional enhancement for newspaper classified ads involves advertisers, particularly employers placing employment ads, who include web addresses in their classified ads so that the readers can use web browsers to get more information by visiting their websites. But, the web addresses placed in the ads lack consistent standards. An advertiser may just include the company website address (Internet domain name) to save ad space, but the readers may have to browse through the website to find the relevant web pages. On the other hand, another advertiser may include a full web address for an ad item, but the readers may have to type a long web address. Additionally, company website addresses vary not only in length but also in spelling, this may cause inconvenience to the readers. Furthermore, the web page styles and layouts also lack consistent standards from ad to ad. This adds complexity and difficulty to the readers. Still furthermore, average advertisers or sellers typically do not have their own websites or do not have the knowledge or cost incentive to prepare web pages for their classified ads. Still furthermore, the web pages for classified ads from different advertisers are independent and spread all over the Internet, making it impossible or inefficient for the readers to electronically search and compare classified ads.

Other enhancement for newspaper classified ads, as illustrated by U.S. Pat. No. 6,253,188, involves publishers who provide electronic versions of their newspaper ads on their websites so that the readers can connect to their web servers to search for and obtain classified ads. But, the readers cannot search and compare classified ads across independence newspapers from different publishers. Moreover, the electronic version, being initiated by publishers, neither provides more information than the printed ad version, nor tailors to the need of particular advertisers.

### SUMMARY OF THE INVENTION

According to one aspect of the invention, a method is provided for enhancing newspaper classified ads via a centralized system. The method introduces a registry website, which acts as a fourth party in addition to other three parties: the publishers, the sellers, and the buyers. The registry website allows sellers to register their ads on the website before submitting them to publishers.

According to another aspect of the invention, a method is provided for uniquely identifying classified ads that may spread all over newspapers from the same or different publishers.

According to another aspect of the invention, a method is provided for sellers to obtain web addresses for newspaper classified ads and include them in the ads.

According to another aspect of the invention, a method is provided for generating newspaper ad web addresses that are short, simple and consistent across different ads and different newspapers from different publishers.

According to another aspect of the invention, a method is provided for offering a uniformed web page style and layout that are consistent across different ads and different newspapers from different publishers.

According to another aspect of the invention, a method is provided for sellers to extend limited item description in newspaper ads via web pages, regardless whether they have their own websites.

According to another aspect of the invention, a method is provided for buyers to search and compare newspaper classified ads across newspapers from different publishers.

According to another aspect of the invention, a method is provided for allowing sellers to select the option of selling ad items on the registry website in addition to registering the ads.

According to another aspect of the invention, a method is provided for sellers to register their classified ads and sell the associated items in a single action on the registry website.

According to another aspect of the invention, a method is provided for buyers to view classified ads and buy the associated items on the registry website.

According to another aspect of the invention, a method is provided for allowing a seller to register a classified ad on the registry website and automatically submit a short version of the ad to one or more publishers for newspaper insertion.

According to another aspect of the invention, a method is provided for enabling a seller to generate sales lead for other unadvertised items with a single newspaper classified ad.

Still further objects and advantages of the invention will become apparent from a consideration of the following description and drawings.

### BRIEF DESCRIPTION OF THE DRAWINGS

These and other more detailed and specific features of the present invention are more fully disclosed in the following description, reference being had to the accompanying drawings, in which:

FIG. 1 illustrates a registry website in relation to sellers, buyers and publishers.

FIG. 2 illustrates components involved in the registry server system.

FIG. 3 is a flowchart illustrating the steps performed by a seller using the registry website.

FIG. 4 illustrates a web page presented to a seller after the seller registers and submits an ad to the registry server system.

FIG. 5 illustrates a newspaper classified ad with its associated registry web address.

FIG. 6 is a flowchart illustrating the steps performed by a buyer using the registry website.

FIG. 7 illustrates a registry web address for a newspaper classified ad being entered into a web browser address box to view the extended ad details.

FIG. 8 illustrates a web page with extended information for a newspaper classified ad that has been registered on the registry website.

FIG. 9 is a flowchart illustrating the steps performed by the registry website.

FIG. 10 illustrates the registry website as a one-stop-shop center for sellers.

FIG. 11 illustrates the structure of a registry web address for classified ad.

FIG. 12 shows an example of a newspaper classified ad with another form of the registry web address that contains a phone number instead of the ad id number.

### DETAILED DESCRIPTION OF THE INVENTION

In the following description, for purposes of explanation, details are set forth, such as a system diagram and a process flowchart, in order to provide an understanding of one or more embodiments of the present invention. However, it is and will be apparent to one skilled in the art that these specific details may not be the only configuration in order to practice the present invention.

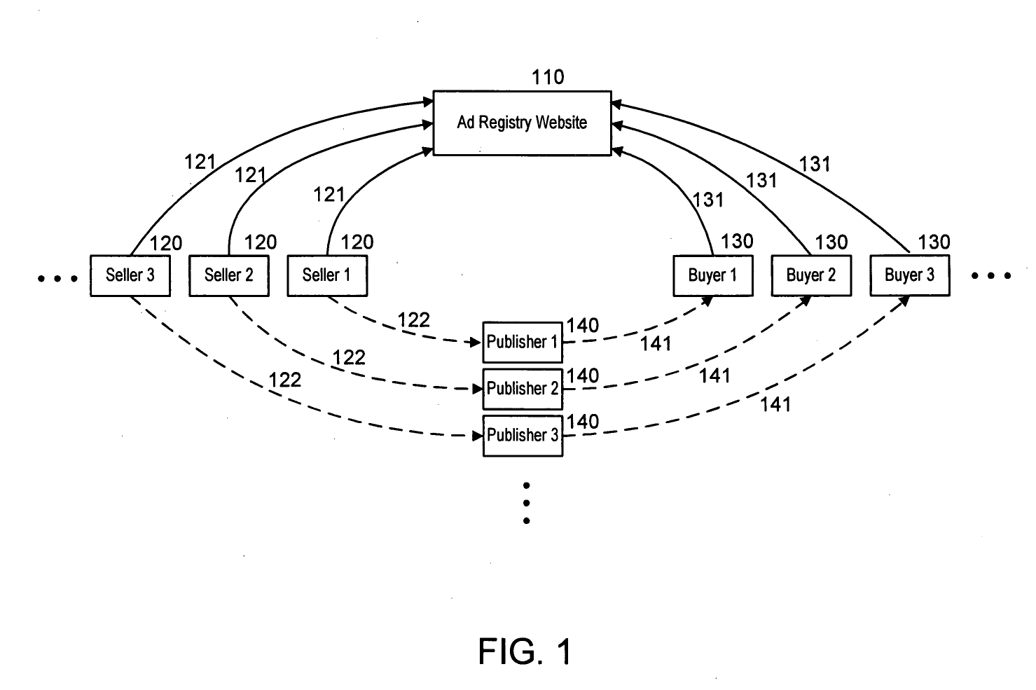

An embodiment of the present invention introduces a registry website into the traditional newspaper advertising system with other three parties involved: the sellers, publishers, and the buyers. FIG. 1 illustrates the registry website in relationship to the other parties. A particular seller 120 connects to the registry website 110 via an Internet link 121; registers an ad with details; obtains a web address specifically associated with the ad (“the ad's registry web address” or “the ad's web address”); and contacts a particular newspaper publisher 140 for placing a classified ad with the web address inclusion. The link 122 represents, typically, a phone call communication, but can be one of other communication types such as fax, email, etc. The publisher delivers the newspaper to a particular buyer 130 as indicated by arrow 141, which typically represents a mechanical delivery, but can also be other electronic means. The buyer reads the newspaper classified ad; connects, with the ad's registry web address, to the registry website 110 via an Internet link 131 for viewing the ad details; and optionally buys the ad item directly on the website.

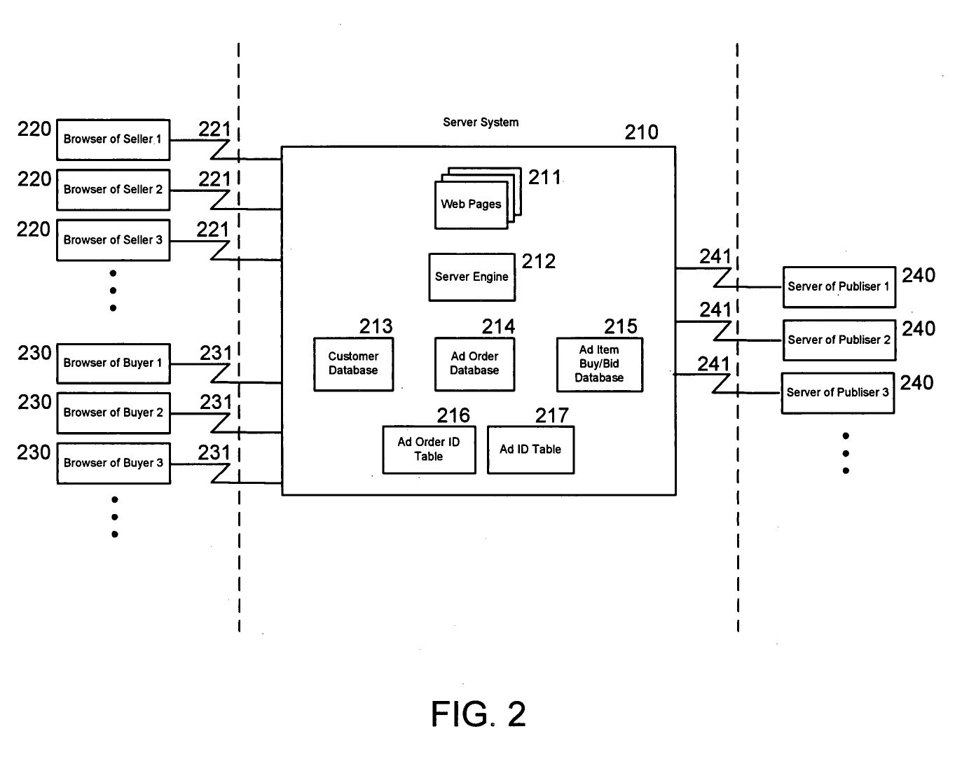

According to one embodiment of the present invention, FIG. 2 illustrates the registry server system 210 that forms the registry website 110 (in FIG. 1). The server system includes a server engine 212, various web pages 211, a Customer database 213, an Ad Order database 214, an Ad Item Buy/Bid database 215, an Ad Order ID table 216, and an Ad ID table 217. The server engine performs such tasks as retrieving data from databases, generating web pages, and saving user data to databases etc. A particular seller browser computer 220 connects to the server system via an Internet link 221. A particular buyer browser computer 230 connects to the server system via an Internet link 231. The server system may connect to a particular publisher server 240 via link 241, which may be an Internet or intranet link.

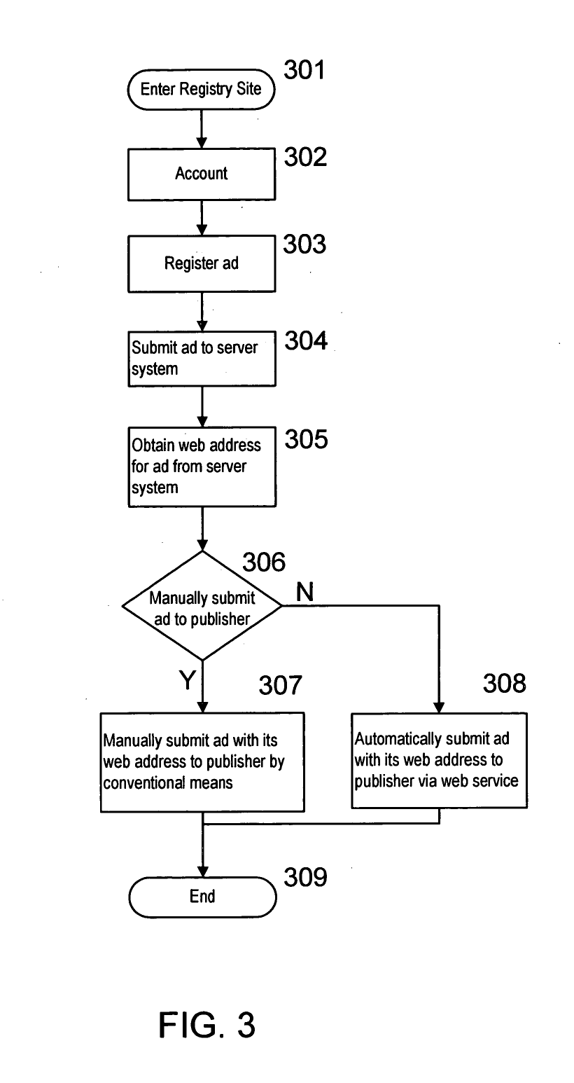

FIG. 3 presents a flow diagram of steps performed by a seller who uses the registry website 110 (in FIG. 1) for enhancing a newspaper classified ad. In step 301, a seller 120 (in FIG. 1) uses a web browser computer 220 (in FIG. 2) to visit the registry website. In step 302, the seller logs in by entering a username and a password (or creates an account with username and password if not done so before). In step 303, the seller registers an ad and specifies ad details (such as description, pictures for upload, ad duration, item price and phone number etc) by filling out web pages provided by the server system 210 (in FIG. 2). On one of the web pages, the seller may select whether or not he or she also wants to sell the ad item on the registry website. In step 304, the seller submits the filled-out ad information to the server system. In step 305, the seller obtains the ad's registry web address. In step 306, the seller selects whether or not to manually submit the ad to a publisher 140 (in FIG. 1). If yes, the seller submits the ad along with the ad's registry web address to the publisher by conventional means (typically by phone call) in step 307. Otherwise, the server system automatically submits the ad and its registry web address to the publisher's web server 240 (in FIG. 2) via standard web service in step 308. Then, the process may end in step 309.

The account information in step 302 may be saved to the Customer database 213 (in FIG. 2). The information entered in step 303 may be saved to the Ad Order database 214 (in FIG. 2). After receiving the information submitted by the seller in step 304, the server engine assigns a unique ad order identifier (Ad Order ID) to the ad, and stores the Ad Order ID (together with other ad identifying information such as phone number and username) in the Ad Order ID table 216 (in FIG. 2). The Ad Order ID may be used to form the web address for the ad. But, as more ads get registered over time, the Ad Order ID can become very long. Therefore, another unique ad identifier (Ad ID) is also used to temporarily represent the ad during its duration. After the ad expires, the Ad ID may be recycled and used for another new ad. The server engine assigns, updates and stores the Ad ID in the Ad ID table 217 (in FIG. 2). Internally, the server system may use the Ad Order ID to permanently and uniquely identify a registered ad and its other associated parameters such as Ad ID, phone number, and username.

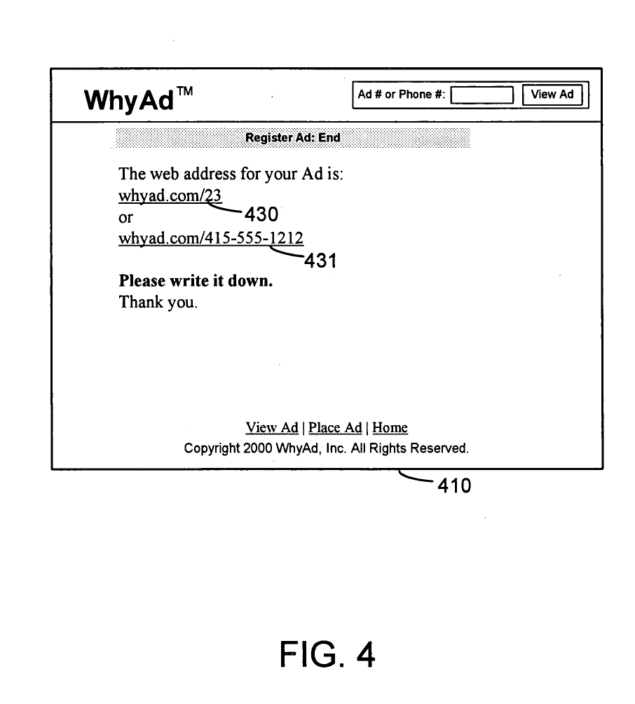

FIG. 4 illustrates an example of a web page presented to the seller after step 304. The web page 410 contains a registry web address 430 for the ad: whyad.com/23. In the example, the domain name of the registry website is whyad.com, and the Ad ID for the ad is 23. Optionally, the seller's phone number may also be used to form the ad's registry web address 431. The server engine may use the phone number to find all ads registered by the seller from the Ad Order database.

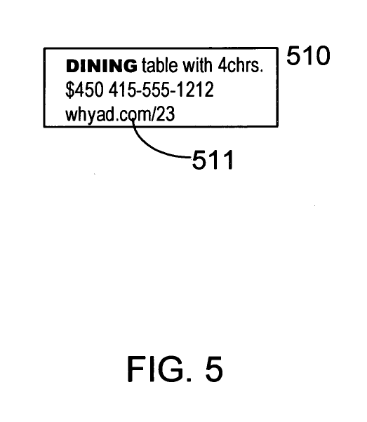

FIG. 5 illustrates an example of the corresponding newspaper classified ad with its registry web address. The newspaper ad 510 has its registry web address 511, which is whyad.com/23.

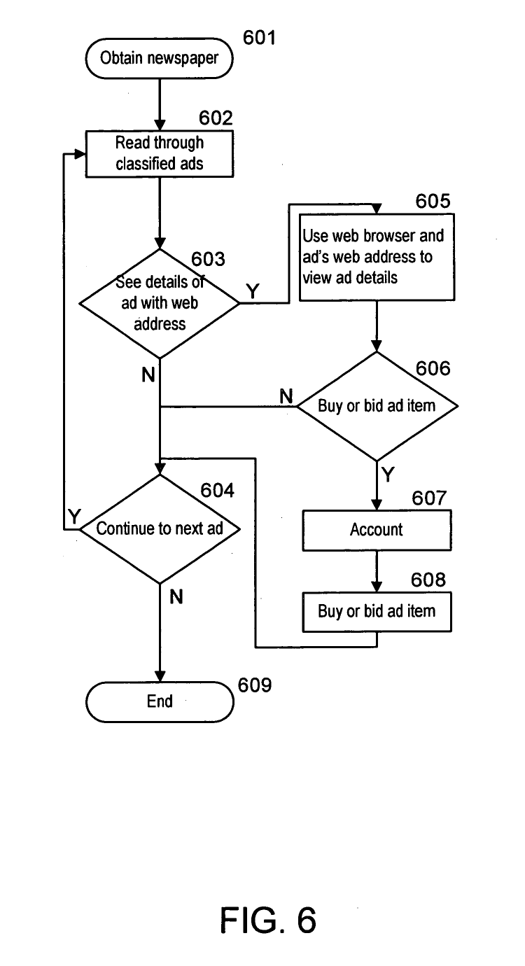

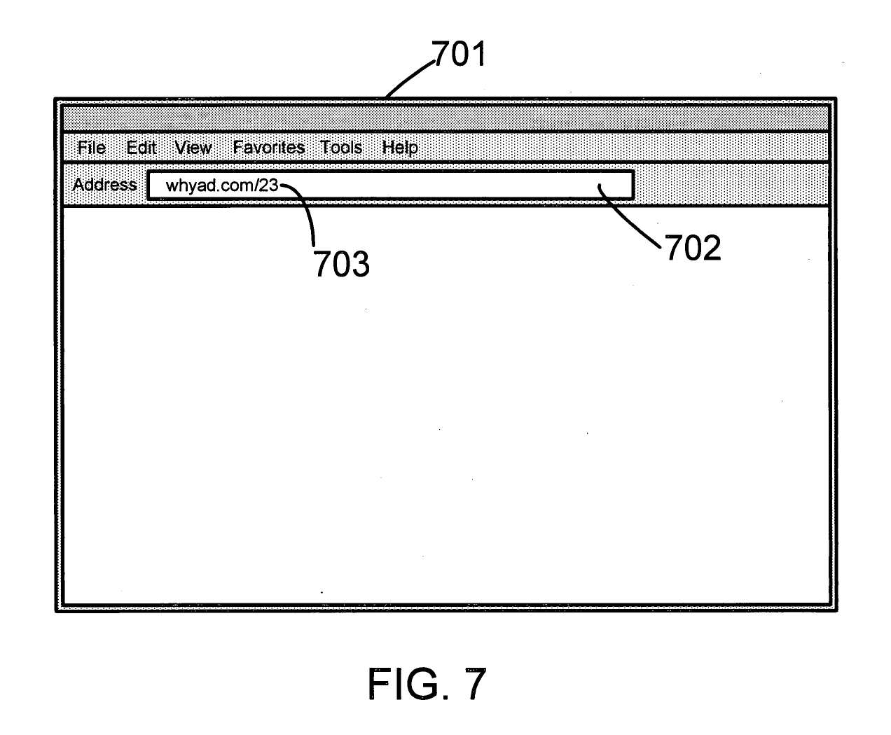

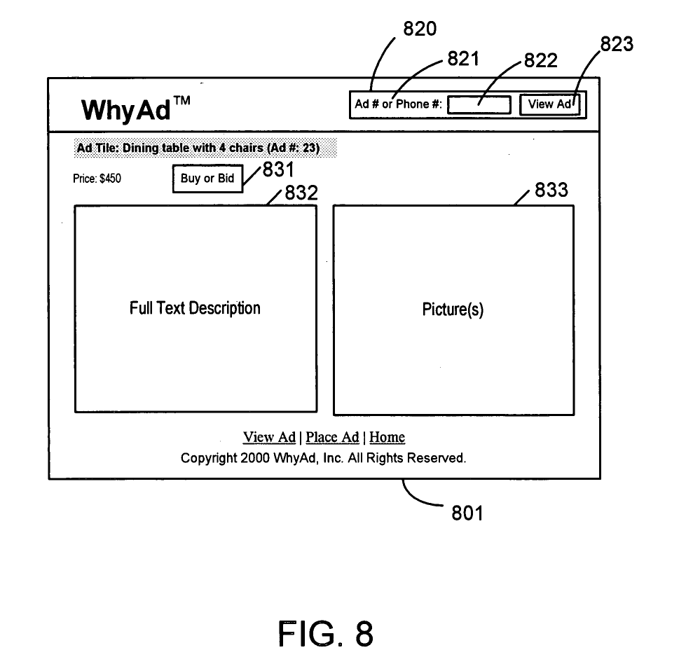

FIG. 6 shows a flow diagram of steps performed by a buyer who reads newspaper classified ads that have been registered on the registry website. In step 601, a buyer 130 (in FIG. 1) obtains newspaper. In step 602, the buyer reads through classified ads in the newspaper. In step 603, the buyer decides whether or not to see details of a particular ad with its registry web address (refer to FIG. 5 for example). If no, the buyer proceeds to step 604. If yes, in step 605, the buyer uses a web browser computer 230 (in FIG. 2) and the ad's registry web address (refer to FIG. 5 and FIG. 7) to view the ad details via a web page (refer to FIG. 8) provided by the server system 210 (in FIG. 2). In step 606, the buyer decides whether or not to buy or bid the ad item. If no, the buyer proceeds to step 604. If yes, in step 607, the buyer logs in by entering a username and a password (or creates an account if not done so before). In step 608, the buyer buys or bids the ad item (refer to the Buy or Bid button 831 in FIG. 8). Then, the buyer proceeds to step 604 where the buyer decides to end in step 609 or continue to the next ad by going back to step 602. The buy/bid information in step 608 may be saved to the Ad Item Buy/Bid database 215 (in FIG. 2).

FIG. 7 illustrates a registry web address 703 for a newspaper classified ad being entered into the address box 702 of a web browser 701 to view the extended ad details in step 605 (in FIG. 6).

FIG. 8 illustrates an example of a web page with extended information for a newspaper classified ad that has been registered on the registry website. The ad detail web page 801 for the registered newspaper ad may include full text description 832 and picture display 833. On the same web page, a buyer can directly press a button 831 (which may link to another web page) to buy or bid the ad item. The web page may have a View Ad section 820, which contains a label 821, a text box 822 and a button 823. The View Ad section allows a buyer to conveniently view other registered ads from the newspaper by simply entering an Ad ID into the text box 822 without the registry website domain name. For instance, to view the ad details for the newspaper ad 510 (in FIG. 5), a buyer can simply enter 23 (the Ad ID) into the text box 822 instead of using whyad.com/23 (the ad's full registry web address) illustrated in FIG. 7. Therefore, in step 605 (in FIG. 6), by keeping the ad detail web page 801 open after viewing a registered newspaper ad, the buyer can conveniently type the next Ad ID and view the next registered ad from the newspaper in the loop formed by step 604 and step 602 (in FIG. 6). Optionally, a buyer may enter a seller's phone number into the text box 822 to find out all ads available from a particular seller. The View Ad section can also be provided on other web pages (see FIG. 4 for example) so that its convenience is accessible throughout the website.

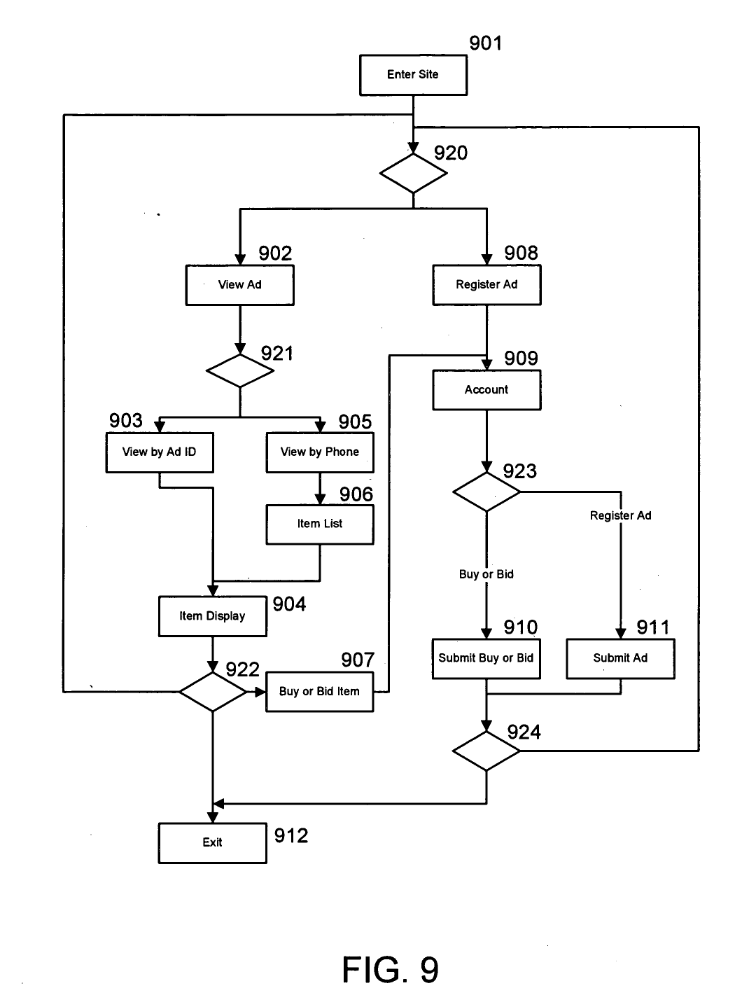

According to one embodiment of the present invention, FIG. 9 shows a block diagram of steps performed by the server system. In step 901, the server system lets a server client (typically a buyer or a seller) to enter the registry website. In step 920, the server system provides to the client the option of viewing ad in step 902 or registering ad in step 908, which leads to step 909 for account login. If the client goes to step 902, the server system provides to the client the option of viewing ad by Ad ID in step 903 or viewing ad by phone number in step 905. If the client goes to step 903, the server system displays the ad item to the client via a web page in step 904. If the client goes to step 905, the server system displays a list of ad items to the client via a web page in step 906. The server system lets the client to select an item in the list and view the item in step 904. The server system may skip step 906 and go to step 904 if there is only one item associated with the phone number entered in step 905. After step 904, in step 922, the server system provides to the client the option of going back to step 920, buying/biding the item in step 907, or exiting in step 912. Step 907 also leads to step 909 for account login. In step 909, the server system allows the client to log in by entering a username and a password (or create an account if not done so before). After step 909, in step 923, the server system determines whether the account login is for registering ad or for buying/biding ad item. If the account login is for registering ad, the server system allows the client to submit the ad registering information to the server system in step 911. Otherwise, the server system allows the client to submit the buy/bid information to the server system in step 910. Step 910 or setup 911 leads to step 924 where the server system provides to the client the option of exiting in step 912 or going back to step 920.

It is noted that although discussion has been given to classified ads on newspaper, the method and system can be applied to ads on other paper-based media such as magazines, fliers, coupons, and bulletin boards etc. For instance, in FIG. 1, a particular seller 120 may register an ad; place the ad's registry web address on a flyer; and hand the flyer out to a particular buyer 130 without using newspaper from a publisher 140. Then, the diagram block 140 for Publisher may be substituted with Flyer.

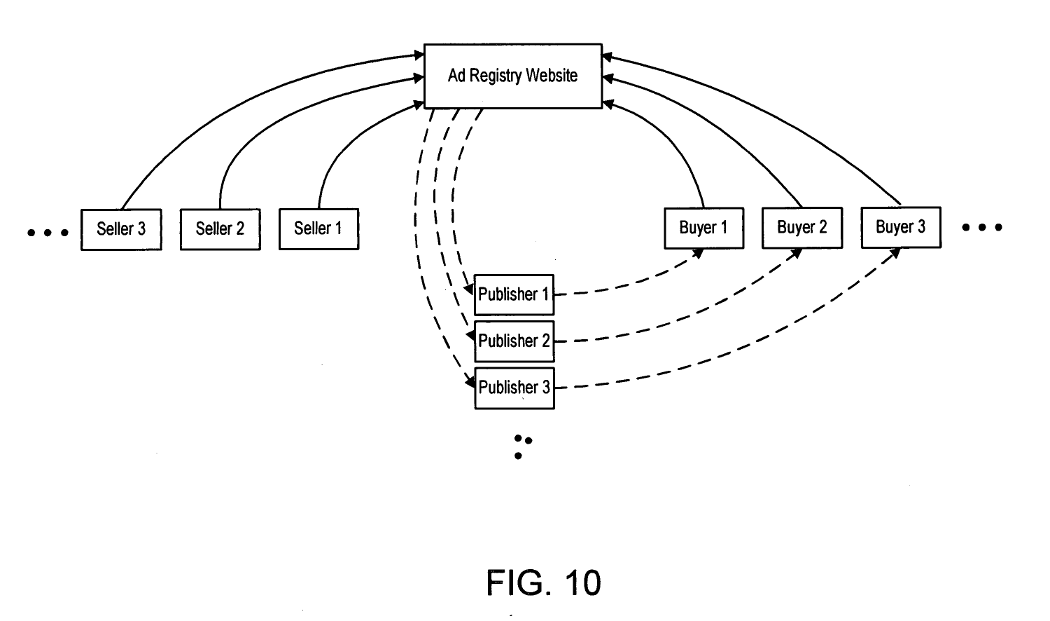

The registry website can also act as a one-stop-shop center for a seller. For instance, in FIG. 1, after a particular seller 120 registers an ad on the registry website 110, the registry website can automatically submit the ad to a particular publisher 140 for publication in newspaper without the need of the seller contacting the publisher. In this case, FIG. 1 then becomes FIG. 10.

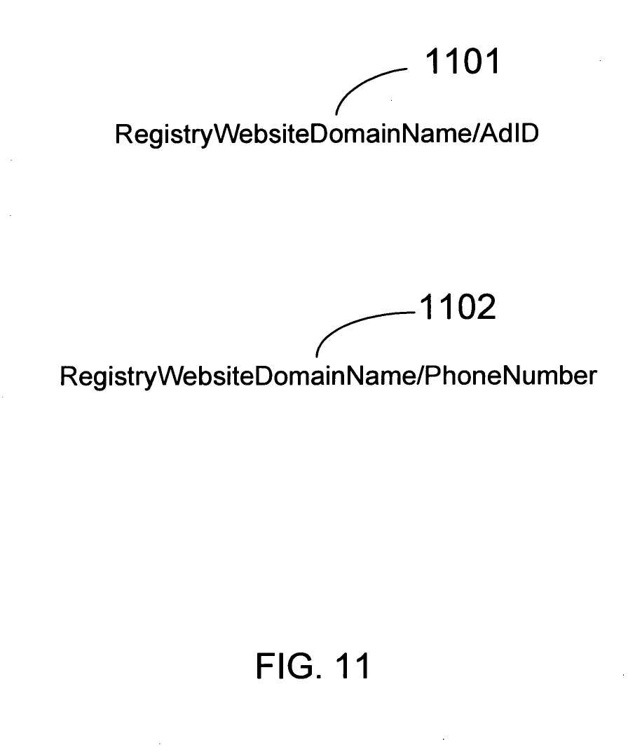

For convenience, the web address for a registered ad formed by the registry website domain name and the Ad ID is defined as “Ad ID registry address”; and the web address for a registered ad formed by the registry website domain name and the seller's phone number is defined as “phone number registry address”. FIG. 11 illustrates the structure for the Ad ID registry address 1101, and the structure of the phone number registry address 1102. As an example, for the Ad ID registry address 430 (whyad.com/23) in FIG. 4, RegistryWebsiteDomainName is whyad.com, and the AdID is 23; and for the phone number registry address 431 (whyad.com/415-555-1212) in FIG. 4, RegistryWebsiteDomainName is whyad.com, and PhoneNumber is 415-555-1212.

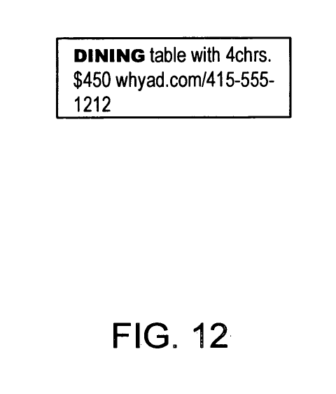

It is noted that a newspaper classified ad usually has the seller's phone number printed on the same ad. According to one embodiment of the present invention, the phone number can be used more cleverly. It can form a phone number registry address for use in a newspaper classified ad. FIG. 12 illustrates a newspaper classified ad with a phone number registry address. In the example, the registry website domain name is whyad.com. The phone number 415-555-1212 is part of the web address (whyad.com/415-555-1212) for the ad. The phone number registry address has several advantages. First, it is short. Second, it tells the website name (whyad.com) for obtaining more information. Third, it tells the phone number (415-555-1212) for contacting the seller. Fourth, it is a qualified web address by itself and can be directly typed into a web browser address box (type whyad.com/415-555-1212 into the box 702 in FIG. 7 for example). Fifth, it allows the seller to place a newspaper classified ad with the phone number registry address first and register the ad on the registry website later. Sixth, it enables the seller to generate sales lead for other unadvertised items with a single ad, as described next. If a seller has multiple items to sell, the seller may register the multiple items one by one with a single phone number on the registry website. For each registered item, the seller obtains a unique Ad ID registry address and the same phone number registry address. If the seller places one newspaper classified ad with the phone number registry address for one item, the item advertised on the newspaper will appear along with the other unadvertised items for a buyer who uses the phone number registry to view the ad on the registry website.

A seller can use either the Ad ID registry address or the phone number registry address in a classified ad, depending on individual preference and specific need.

It is noted that for displaying ad details, the registry website provides a uniformed web page style and layout that are consistent across different ads and different newspapers from different publishers.

It is further noted that although registered ads may be for classified ads on different newspapers, they are centrally stored in the Ad Order database on the server system and therefore can be searched. This allows a buyer to search and compare newspaper classified ads across newspapers from different publishers.

Thus, the method and system have been provided for enhancing paper-based classified ads. Although the invention has been described in detail with reference to certain embodiments thereof, other embodiments are possible. For instance, although one embodiment may contain components as shown in FIG. 2 or steps as shown in FIG. 9, more or less components or steps may be provided for a similar overall functionality. Therefore, the spirit and scope of the appended claims should not be limited to the description of the preferred embodiments contained herein.

1. A method for registering and enhancing a classified ad, the method comprising:
receiving information for an ad including phone number from an advertiser;
registering said ad on a server system of a website;
assigning said ad a unique identifier;
building a web address for said ad with a direct combination of said website's Internet domain name and said unique identifier or said phone number;
providing said advertiser said web address for inclusion into a paper-based ad such as a newspaper classified ad;
allowing a reader of said paper-based ad to access said ad on said server system with said web address;
displaying detailed information for said ad to said reader;
making said server system concurrently serve other advertisers for ad registering as well as other ad readers for ad detail viewing.

2. A first method for building the web address for an ad in claim 1, the method comprising:
assigning a registered ad a permanent unique identifier; and
forming said web address with the combination of the website's Internet domain name and said permanent unique identifier.

3. A second method for building the web address for an ad in claim 1, the method comprising:
assigning a registered ad a temporary unique identifier;
forming said web address with the combination of the website's Internet domain name and said temporary unique identifier; and
recycling said temporary unique identifier for another new ad after said ad expires.

4. A third method for building the web address for an ad in claim 1, the method comprising:
associating the unique identifier for an registered ad with the advertiser's phone number; and
forming said web address with the combination of the website's Internet domain name and said phone number.

5. The method of claim 1 wherein the order of registering ad and inserting the web address into a paper-based ad may be optionally reversed if said web address is formed with the combination of the website's Internet domain name and the advertiser's phone number.

6. The method of claim 1, further providing web pages each having a text box for ad reader to view an ad by simply entering the associated phone number.

7. The method of claim 1, further providing the advertiser the option of selling ad item in addition to registering ad.

8. The method of claim 1, further providing the ad reader the option of purchasing the ad item while viewing ad details.

9. The method of claim 1, further providing the ad reader the function of searching and comparing ads registered on the server system.

10. The method of claim 1, further providing the advertiser the option of letting the server system automatically submit his or her ad to a publisher for publication of the classified ad with the inclusion of the specially built web address.
